(19) United States
(12) Patent Application Publication
(10) Pub. No.: US 2013/0254524 A1
(43) Pub. Date: Sep. 26, 2013

(54) AUTOMATED CONFIGURATION CHANGE AUTHORIZATION

(71) Applicants: Yariv SNAPIR, Kfar Menahem (IL); Oded Zilinsky, Yehud (IL); Michal Aharon, Haifa (IL)

(72) Inventors: Yariv SNAPIR, Kfar Menahem (IL); Oded Zilinsky, Yehud (IL); Michal Aharon, Haifa (IL)

(21) Appl. No.: 13/424,844

(22) Filed: Mar. 20, 2012

(51) Int. Cl. G06F 9/06

(52) U.S. Cl. 713/100

(57) ABSTRACT

A method for automated configuration change authorization may include automatically discovering configuration change events in an IT system over a period of time. The method may also include extracting configuration change event patterns from the discovered configuration change events over the period of time. The method may further include classifying a configuration change event set as corresponding to a configuration change event pattern of the extracted configuration change event patterns. The method may also include automatically authorizing the configuration change event set. A system and computer readable medium are also described.

### BACKGROUND

Many business organizations invest a substantial effort in monitoring their Information Technology (hereinafter—IT) system to ensure high-quality service and to promote a positive user experience.

Monitoring of an IT system, which is typically embedded in Business Service Management (BSM), involves real-user monitoring as well as virtual-user monitoring. Real user monitoring allows monitoring performance and behavior of the IT system when real users are interacting with the system, in real time, and identify slowdowns or other anomalies in the system.

Virtual-user monitoring may be used in order to provide information about the IT system performance when real users are not using the system (for example, during off hours). This provides early identification of slowdowns, before real users begin to experience the problem.

IT system monitoring typically involves collecting measurements from a vast number of monitors that monitor various parameters (referred to as “metrics”) related to system elements, which are usually referred to as configuration items, or CIs.

There are known monitoring applications that provide IT operators with a topological representation of the monitored IT system, where the IT system is represented by a graph, with the CIs located at nodes of the graph that are connected by arcs that indicate the relations between the connected nodes.

IT operators monitoring IT systems look to identify configuration changes indicative of anomalies, understand their origins, and fix them. However, typically, most configuration changes in an IT system are subsequently authorized as they relate to confirmed or planned changes. It is the IT operator's tedious task to determine which configuration changes should be authorized and which should be treated as anomalies and fixed.

There exist some CMs that include an automated configuration change authorization feature, which is based on policy.

### BRIEF DESCRIPTION OF THE DRAWINGS

Examples are described in the following detailed description and illustrated in the accompanying drawings in which:

FIG. 1 illustrates a configuration management (CM) system with an automated configuration change authorization, according to an example;

FIG. 2 illustrates a method for automated configuration change authorization according to some examples;

FIG. 3 illustrates a list of configuration change events and the extraction of configuration change event patterns, in accordance with some examples;

FIG. 4 illustrates implementation of automated configuration change authorization in accordance with some examples, in a large IT environment;

FIG. 5 illustrates a system for automated configuration change authorization, in accordance with some examples.

### DETAILED DESCRIPTION

Although examples are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

With an ever-growing trend to virtualize and automate data centers, a large IT environment experiences a vast number of changes to its configuration each day. These changes often go beyond the capacity that a traditional change-process can handle. Yet, a person responsible for a subset of the IT configuration (sometimes referred to as “configuration owner”, for example a Windows administrator managing all windows servers or a Microsoft Exchange application owner in charge of running the exchange server system) is required to review and authorize large number of configuration changes that occur in that person's respective area of responsibility (e.g. a new Windows machine is added, a service pack is installed, a virtual machine (VM) in the exchange farm is moved from one physical machine to another, etc.). For a human operator to be able to review and authorize this amount of changes, one must be able to group changes of similar nature as well as to be able to separate the trivial, low-risk changes that happen on a regular basis (and can be automatically authorized) from the exceptional, potentially risky, non-trivial changes that need to be carefully examined. For example: within a week, 1000 servers were updated with the latest windows patch, 500 servers had their anti-virus software updated, 700 (virtual) servers had their memory allocation enhanced from 4 GB to 8 GB, and just one server had its memory reduced from 4 GB to 2 GB.

In the context of the present specification, the term “configuration change” refers to any configuration change that may be detected in an IT system.

In the context of the present specification, the term “configuration change event” refers to an instance of configuration change. A “configuration change event set” refers to a group of configuration change events. An “Event pattern” refers to a configuration change event set that is repeatedly found.

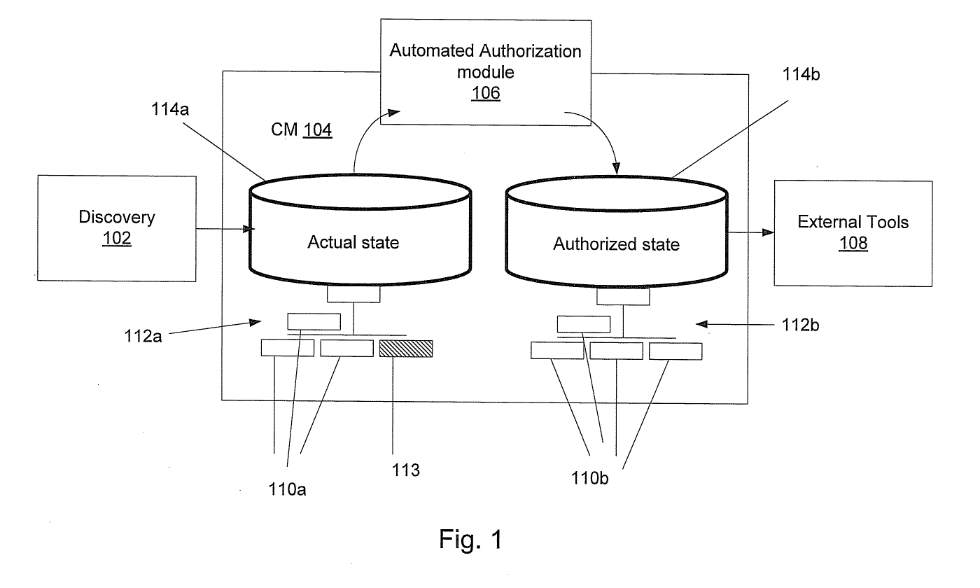

FIG. 1 illustrates a Configuration Management (CM) system 104, which administers a Configuration Management Data Base (CMDB. 114a, 114b), which is a repository of configuration information relating to components of an Information System (IS). Typically the CMDB contains data on configuration items (CIs) of the IT and their mapping (e.g. how the CIs are linked). The CMDB may include information on composite CIs.

A Composite CI is a tree structure in which the root is a high-level IT object and under it related CIs are listed, such as, for example, resource CIs. An example of a Composite CI is a Node (Host) where the Node CI includes the root CI and the CPU, with a File-System and IP-Address listed under it. The Composite structure serves as the first-level capability of aggregating changes to a configuration change event pattern, e.g. different changes in CIs that are part of the same Composite CI structure and that occur in close time proximity are probably related. An example would be an increase in File-System size along with an operating System update that happens over a short time frame.

A discovery application 102 (e.g. a bot) is designed to search the IS and look for CIs and changes in configuration of CIs of the IS. Such changes may include, for example, installation of a new CI in an existing complex CI, updating an operating system, installing new software, etc. The configuration information gathered by the discover application 102 is forwarded to CM 104, which updates the CMDB 114a to reflect the current actual state of configuration of the IS. In accordance to some examples, details of the discovered configuration changes are logged in the CMDB. According to examples, CM 104 may aggregate configuration change meta-data to create time related snapshots of the IT system of configuration state instances (configuration history). The snapshots allow the IT operator to review older configuration instances to explore configuration changes in the IT system over a period of time.

For example, CM 104 may receive a stream of configuration change events from the CMDB, and aggregate these configuration change events under composite CIs. The number of configuration change event types may be limited to, for example, a list of configuration changes that typically occur in common configuration change actions.

For example, the configuration change event types may be limited to: the addition of a composite CI of type T (e.g. the discovery of a newly added Windows server), addition of a component CI of type C to a composite CI of type T (e.g. a new file system is added to a Windows server), removal of a composite CI of type T (e.g. a Windows server is removed or deleted), removal of a component CI of type C from a composite CI of type T (a file system is removed from a Windows server), updating of an attribute A of composite CI of type T to a new value V (e.g. a service pack version is updated on a Windows server), updating attribute A to Value V for Component CI of Type C in a Composite CI of type T (e.g. the file system size is increased for a file-system E on a Windows server), addition of a link of type L between a source CI of type S and a target CI type T (e.g. a containment link is detected between a web logic server and a Windows server), removal of a link of type L between a source CI of type S and a target CI type T (e.g. a membership link is removed between a J2EE cluster and a web logic server).

The deployment of a new server in an IT system may involve the discovery of a number of typical configuration changes that may include, for example, detecting a breach on a cluster of CIs, determining that a server has been added to the cluster, detecting a new VM which may include a new CPU, a new file system and a new IP, detecting a new breach status of the VM, detecting a new link between the VM and UNIX, detecting new software, and so on.

Automated configuration change authorization module 106 implements a method for automated configuration change authorization, as described, for example, hereinafter, to identify and authorize configuration changes to the IT system that are determined to be in order. For example, CI 113, is identified as changed in the IT map 112a of the IT system. Map 112a also includes CIs 110a whose configuration has not changed). If automated configuration change authorization module 106 determines that the change is proper the CMDB is updated to an authorized state 114b, in which all of the CIs 112b are cleared to be in order.

In some examples, CM 104 is configured to explore any configuration state instance (e.g. current configuration state instance or past configuration state instance).

In some examples, CM 104 is configured to present to the IT operator with configuration information of the IT system and indicate which changes were automatically authorized. In some examples, CM 104 may allow the IT operator to overturn an automated decision of authorization (e.g. if the IT operator determines that the authorized configuration change is improper).

In some examples, CM 104 is further configured to allow the IT operator to manually authorize configuration changes, if the IT operator determines that the configuration change is proper.

In some examples the CM presents the IT operator with configuration change details, potentially related requests for changes (RFC), as well as compliance information that relates to a configuration policy.

In an ideal configuration change process, every RFC would be modeled to precisely reflect the configuration changes expected to a CI or to the topology of the IT system. However, this is rarely the case. The effort to model each RFC in such a way is great—most organizations do not employ RFC modeling techniques for monitoring configuration changes. When the RFC is not modeled, it becomes very hard to correlate it to an actual detected change. For this reason RFCs would probably not be effective in supporting an automatic authorization decision process.

In some examples, the CM indicates to the IT operator configuration those changes that are potentially risky. For example, a graphical presentation of the configuration change events may be provided in which configuration change events which are unclassified are distinctly indicated, e.g. in a distinct color or other graphical indication.

For example, these configuration changes may be presented in red, or otherwise distinctly marked.

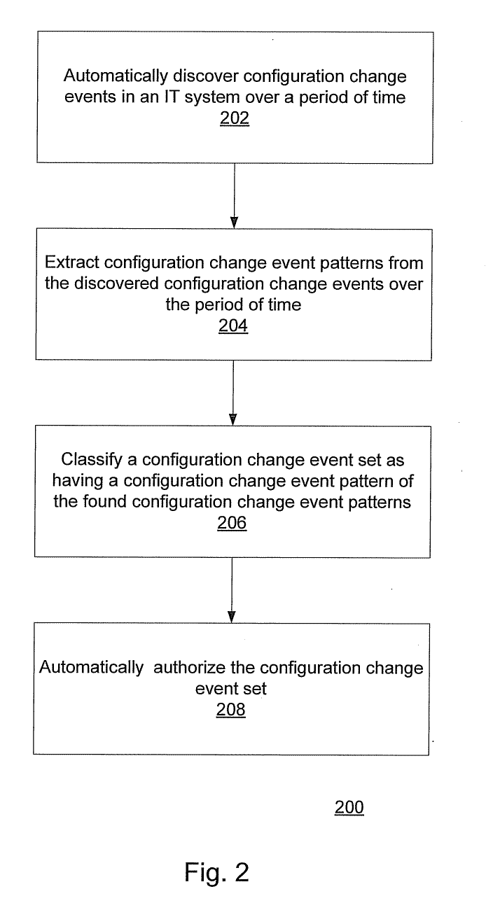

FIG. 2 illustrates a method for automated configuration change authorization according to some examples. Method 200 for automated configuration change authorization may include automatically discovering 202 configuration change events in an IT system over a period of time. The method may also include extracting 204 configuration change event patterns from the discovered configuration change events over the period of time. The method may further include classifying 206 a configuration change event set as having a configuration change event pattern of the extracted configuration change event patterns. The method may also include automatically authorizing 208 the configuration change event set.

In some examples, an event correlation algorithm for identifying patterns may be used to detect configuration change event pattern and to classify a configuration change event set as having a configuration change event pattern.

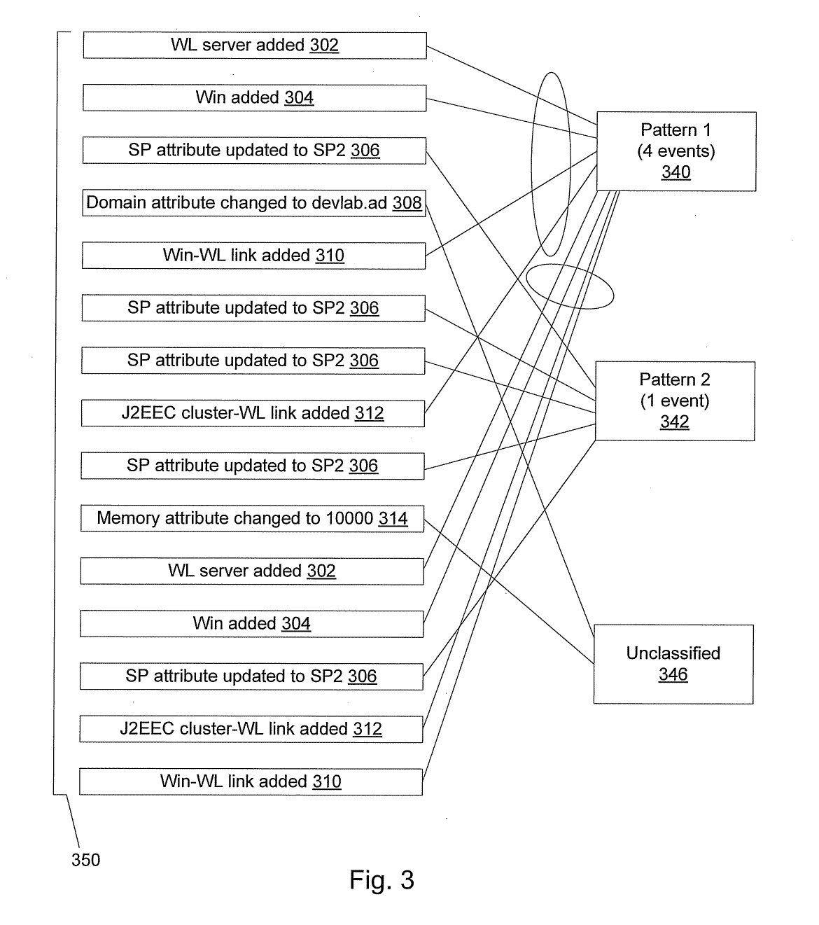

FIG. 3 illustrates a list of configuration change events and the extraction of configuration change event patterns, in accordance with some examples.

In the example of FIG. 3 the list shown includes configuration change events that have been discovered over a period of time T indicated by timeline 350.

By employing a detection technique to find configuration change event patterns, e.g. by using an event correlation algorithm, two patterns are found. In one pattern 340 4 events are included: WL server added 302, Win added 304, Win-WL link added 310, and J2EEC cluster added. Another pattern 342 includes a single event: SP attribute updated to SP2 306. Two events remain unclassified 346: Domain attribute changed to devlab.ad 308 and memory attribute changed to 10000 314.

After extracting the configuration change event patterns, configuration change events may be discovered and event sets may be compared to the extracted patterns and classified as one of them when the same configuration change events appear in these event sets.

The order of the configuration change events in a configuration change pattern may be important in some cases, whereas in other cases the order may not be important. For example, if a configuration change event pattern relates to an automated configuration action, then the order of events would typically be the same for that pattern. The order of events in such a case may help in determining whether an event set may indeed be determined to be relating to an existing configuration change event pattern or not. However, typically in most cases, when a configuration change action involves a number of steps which may be performed in any order, then the order of configuration change events for that configuration change event pattern would not be considered.

Extracting configuration change event patterns may depend on the length of the time period to which the extraction relates. The larger the time period, the more configuration change event patterns would be extracted. This may reduce the ability to correlate patterns. Thus, if a real-time or near real-time discovery of configuration changes is employed, there is a better chance that configuration change event sets relating to the same origin (e.g. same automation) would be discovered and logged, and hence determined to be relating to a single configuration change event pattern.

In some examples, the time period may span over a few hours.

In some examples, only configuration changes that relate to a relatively small environment of the IT system may be considered. This may facilitate determination of stronger correlations, as in many instances a configuration change set of events relates to a single composite CI or to a plurality of neighboring composite CIs.

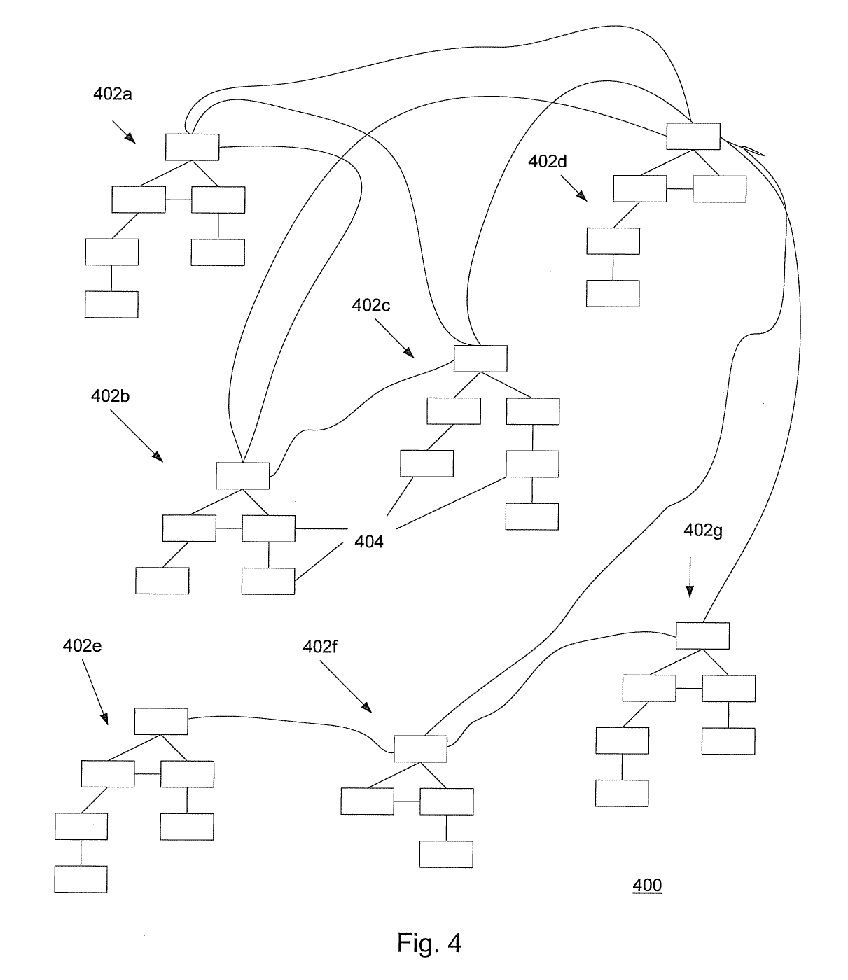

FIG. 4 illustrates implementation of automated configuration change authorization in accordance with some examples, in a large IT environment.

IT system 400 may include numerous composite CIs (402a-402g), each including one or more CIs 404. The CIs may include different configuration items of many kinds, but for sake of brevity the different kinds are not indicated in the figure.

Some of the composite CIs are connected to many other composite CIs (402a, 402b, 402c, 402d), whereas other composite CIs are connected to a few other composite CIs (402e, 402f, 402g). Thus, according to some examples, automated configuration change authorization is implemented while considering only neighboring CIs. For example, automated configuration change authorization may be implemented by referring only to configuration changes in neighboring CIs and their environment (links). Composite CIs 402e, 402f and 402g are good candidates for this as they are linked closely, while relatively distant (in terms of links) from other composite CIs. Composite CI 402e is only linked to composite CI 402f, whereas composite CI 402f is linked to composite CI 402e, composite CI 402g and composite CI 402d. Composite CI 402g is linked to composite CI 402f and to composite CI 402d.

Thus, based on knowledge of the topology of the IT system, knowledgeable treatment of local IT environments (e.g. the IT environment that includes composite CIs 402e, 402f and 402g) can more effectively assist in proper extraction of configuration change event patterns as well as in classification of later discovered configuration change event sets that are related to one of the extracted configuration patterns.

Indeed, it is assumed that most configuration changes are a result of automatic action flows or repeated, scheduled actions. Thus most discovered configuration change events should be identified as proper configuration change actions and authorized accordingly.

Thus, automated configuration change authorization, in accordance with some examples, may significantly reduce the work of the IT operator when monitoring configuration changes in the IT system and authorizing configuration changes.

An automated configuration change authorization, in accordance with examples, may offer the IT operator additional insight for configuration state management.

In some examples, configuration change events that are associated with a single configuration change event pattern may be graphically grouped, or otherwise distinctly marked or indicated.

In some examples, the IT operator may quickly accept the authorization of configuration change event sets that were automatically authorized employing a method for configuration change authorization. This would allow the IT operator to focus more on unclassified configuration change events, which are potentially problematic or even risky.

In some examples, the unclassified configuration change events may be graphically grouped, distinctly marked or otherwise indicated for extra attention.

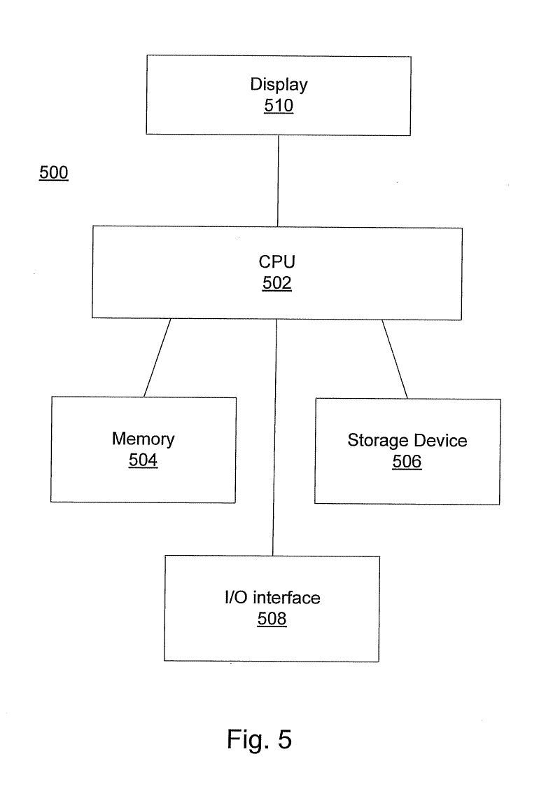

FIG. 5 illustrates a system for automated configuration change authorization, in accordance with some examples. System 500 may include a central processing unit (CPU) 502, to execute a set of instructions to perform a method for automated configuration change authorization according to some examples. System 500 may further include a volatile short term memory 504, and a non-transitory storage device 506, such as for example, a hard-disk, flash memory etc. for storing a computer program for automated configuration change authorization, such as described hereinabove. System 500 may also include an input/output (I/O) interface 508, for interfacing with other devices, and a display device 510, for displaying configuration information, either in textual form or in graphical form.

System 500 may further include additional components as needed or desired.

In some examples, system 500 may be a computer system executing other CM applications, and other application that do not relate directly to CM.

Examples may be embodied in the form of a system, a method or a computer program product. Similarly, examples may be embodied as hardware, software or a combination of both. Examples may be embodied as a computer program product saved on one or more non-transitory computer readable medium (or mediums) in the form of computer readable program code embodied thereon. Such non-transitory computer readable medium may include instructions that when executed cause a processor to execute method steps in accordance with examples. In some examples the instructions stores on the computer readable medium may be in the form of an installed application and in the form of an installation package.

Such instructions may be for example loaded into one or more processors and executed.

For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer, or on a plurality of computers.

Examples are described hereinabove with reference to flowcharts and/or block diagrams depicting methods, systems and computer program products according to examples.

What is claimed is:

1. A method for automated configuration change authorization comprising:
automatically discovering configuration change events in an IT system over a period of time;
extracting configuration change event patterns from the discovered configuration change events over the period of time;
classifying a configuration change event set as corresponding to a configuration change event pattern of the extracted configuration change event patterns; and
automatically authorizing the configuration change event set.

2. The method of claim 1, further comprising using an event correlation algorithm for extracting the configuration change event patterns and for classifying the configuration change event set as corresponding to a configuration change event pattern of the extracted configuration change event patterns.

3. The method of claim 1, further comprising allowing overturning an automated authorization decision relating to the configuration change event set.

4. The method of claim 1, further comprising providing a graphical presentation of the configuration change events and distinctly indicating configuration change events of the classified configuration change event set.

5. The method of claim 1, further comprising providing a graphical presentation of the configuration change events and distinctly indicating configuration change events which are unclassified.

6. The method of claim 1, further comprising performing the method on a local environment of the IT system.

7. The method of claim 1, wherein the time period is of several hours.

8. A non-transitory computer readable medium having stored thereon instructions for automated configuration change authorization, which when executed by a processor cause the processor to perform the method of:
extracting configuration change event patterns from configuration change events discovered in an IT system over the period of time;
classifying a configuration change event set as corresponding to a configuration change event pattern of the extracted configuration change event patterns; and
automatically authorizing the configuration change event set.

9. The non-transitory computer readable medium of claim 8, further comprising discovering the configuration change events discovered in the IT system.

10. The non-transitory computer readable medium of claim 8, wherein the method further comprises using an event correlation algorithm for extracting the configuration change event patterns and for classifying the configuration change event set as corresponding to a configuration change event pattern of the extracted configuration change event patterns.

11. The non-transitory computer readable medium of claim 8, wherein the method further comprises allowing overturning an automated authorization decision relating to the configuration change event set.

12. The non-transitory computer readable medium of claim 8, wherein the method further comprises providing a graphical presentation of the configuration change events and distinctly indicating configuration change events of the classified configuration change event set.

13. The non-transitory computer readable medium of claim 8, wherein the method further comprises providing a graphical presentation of the configuration change events and distinctly indicating configuration change events which are unclassified.

14. The non-transitory computer readable medium of claim 8, wherein the method further comprises performing the method on a local environment of the IT system.

15. The non-transitory computer readable medium of claim 8, wherein the time period is of several hours.

16. A system for automated configuration change authorization, the system comprising:
a processor to:
automatically discover configuration change events in an IT system over a period of time;
extract configuration change event patterns from the discovered configuration change events over the period of time;
classify a configuration change event set as corresponding to a configuration change event pattern of the extracted configuration change event patterns; and
automatically authorize the configuration change event set.

17. The system of claim 16, wherein the processor is configured to use an event correlation algorithm to extract the configuration change event patterns and to classify the configuration change event set as corresponding to a configuration change event pattern of the extracted configuration change event patterns.

18. The system of claim 16, wherein the processor is further configured to allow overturning an automated authorization decision relating to the configuration change event set.

19. The system of claim 16, wherein the processor is further configured to provide a graphical presentation of the configuration change events and distinctly indicating configuration change events of the classified configuration change event set.

20. The system of claim 16, wherein the processor is further configured to provide a graphical presentation of the configuration change events and distinctly indicating configuration change events which are unclassified.
